(19) United States
(12) Patent Application Publication
(10) Pub. No.: US 2016/0315854 A1
(43) Pub. Date: Oct. 27, 2016

(54) SYSTEM AND METHOD OF SIGNALING PROTECTION PATH BINDINGS

(71) Applicant: Alcatel-Lucent USA Inc., Murray Hill, NJ (US)

(72) Inventor: Srikrishnan Venkataraman, Santa Clara, CA (US)

(73) Assignee: ALCATEL-LUCENT USA INC., Murray Hill, NJ (US)

(21) Appl. No.: 14/697,033

(22) Filed: Apr. 27, 2015

(51) Int. Cl. H04L 12/723; H04L 12/703; H04L 12/913

(52) U.S. Cl. CPC H04L 45/50; H04L 47/724; H04L 45/28

(57) ABSTRACT

A system, method and apparatus for signaling path binding information between end nodes of a Generalized Label Switched Path working path to provide controlled and rapid switching by both end nodes from a failed or failing working path to a protected path.

### FIELD OF THE INVENTION

The invention relates to the field of communication networks such as generalized multi-protocol label switching (GMPLS) networks and, more particularly but not exclusively, to enabling ingress and egress node signaling of protection path bindings such as where a N+1 protection scheme is deployed.

### BACKGROUND

Multiprotocol Label Switching (MPLS) enables efficient delivery of a wide variety of differentiated, end-to-end services. Multiprotocol Label Switching (MPLS) traffic engineering (TE) provides a mechanism for selecting efficient paths across an MPLS network based on bandwidth considerations and administrative rules. Each label switching router maintains a TE link state database with a current network topology. Once a path is computed, TE is used to maintain a forwarding state along that path.

An Internet Engineering Task Force (IETF) document denoted as Request for Comment (RFC) 4872 describes protocol-specific procedures and extensions for Generalized Multi-Protocol Label Switching (GMPLS) Resource Reservation Protocol—Traffic Engineering (RSVP-TE) signaling to support end-to-end Generalized Label Switched Path (GLSP) recovery via path protection and restoration.

A generic functional description of GM PLS recovery can be found in a companion document, RFC 4426. In general, the signaling for GMPLS is used to establish Bi-Directional connections across an optical domain between ingress/egress IP nodes, and RSVP-TE is the signaling protocol used for this purpose with GMPLS specific enhancements.

Unfortunately, in the end-to-end protection mechanism defined in RFC 4872 the ingress or egress provider equipment (PE) node does not know whether a given working path is successfully bound, with resources allocated in the Ingress and Egress PE nodes supporting the path. This lack of visibility may result in inconsistent behavior in the end-to-end protection scheme where a switch to a protection path from a failed or failing working path is being performed by one of the end PE nodes, causing potential traffic outages with the switch to the PROTECT PATH serving any purpose. When one of the PE end nodes (ingress or egress) detects a failure, the failure detecting node causes a switch from the failed working path to a protection path that is ultimately mirrored by the other PE end node upon the other PE end node detecting the same failure. This takes time during which data is lost, QoS degraded and so on.

### SUMMARY

Various deficiencies in the prior art are addressed by systems, methods, apparatus, mechanism, telecom network elements and the like for signaling path binding information between end nodes of a working path to provide controlled and rapid switching from a failed or failing working path to a protected path.

Various embodiments provide a method of signaling path bindings supporting a generalized label switched path (LSP) comprising at least one working path and at least one protection path between end nodes. For example, a method according to one embodiments comprises: at an LSP end node, in response to a successful resource binding for said protection path, transmitting a first protection path binding message indicative of said successful resource binding toward an opposite LSP end node via one of a PATH message and an RSVP message.

### BRIEF DESCRIPTION OF THE DRAWINGS

The teachings herein can be readily understood by considering the following detailed description in conjunction with the accompanying drawings, in which:

FIG. 1 depicts a high-level block diagram of a system benefiting from various embodiments;

FIG. 2 depicts a flow diagram of a method according to one embodiment;

FIG. 3 depicts a high-level block diagram of a computing device suitable for use in performing functions described herein;

FIG. 4 depicts an exemplary protection object suitable for use in various embodiments;

FIG. 5 depicts a modified exemplary protection object in accordance with various embodiments;

FIG. 6 depicts an exemplary notify message format suitable for use in various embodiments; and

FIG. 7 depicts an exemplary error code format suitable for use in various embodiments.

To facilitate understanding, identical reference numerals have been used, where possible, to designate identical elements that are common to the figures.

### DETAILED DESCRIPTION OF THE INVENTION

Various embodiments provide systems, methods and/or apparatus for enabling ingress and egress node signaling of protection path resource bindings and/or working path resource bindings, such as where a N+1 protection scheme is deployed. Various embodiments also provide a three way handshaking mechanism enabling rapid communication between ingress and egress nodes to coordinate working path to protection path migration of traffic (i.e., failover to protection path), protection path to restored working path migration of traffic (i.e., restoration of working path) and so on.

Various embodiments adapt a protection object to include data indicative of protection path and/or working path resource binding information, switchover notification, positive or negative acknowledgment of switchover and the like. The protection object may be communicated between an ingress node and an egress node of an GLSP via upstream and downstream messages between the various LSRs forming the GLSP. Generally speaking, RSVP path messages including those with relevant protection object data are propagated downstream from a message originating node (e.g., an ingress node) toward the egress node, while RSVP Resv messages including those with relevant protection object data are propagated upstream from a message originating node (e.g., an egress node) toward the ingress node.

In various embodiments, an N+1 protection scheme where N working optical paths are protected by a single protection optical path, and signaling between end nodes enables both ends of a failed working path to rapidly converge to using the protection path. That is, rather than wait for an indication of failure at the second end node prior to switching from working to protection path (or vice versa), the first end node signals the second end node so that the second node may also switch from working to protection path (or vice versa).

Various embodiments will be described within the context of a GMPLS system wherein Generalized Label Switch Paths providing IP-Optical integration and using RFC-4872-type signaling to achieve end-to-end recovery across the above IP-Optical domain. That is, GLSPs between IP Ingress/Egress nodes or LSRs traverse an optical domain comprising various optical connection, switching and routing devices.

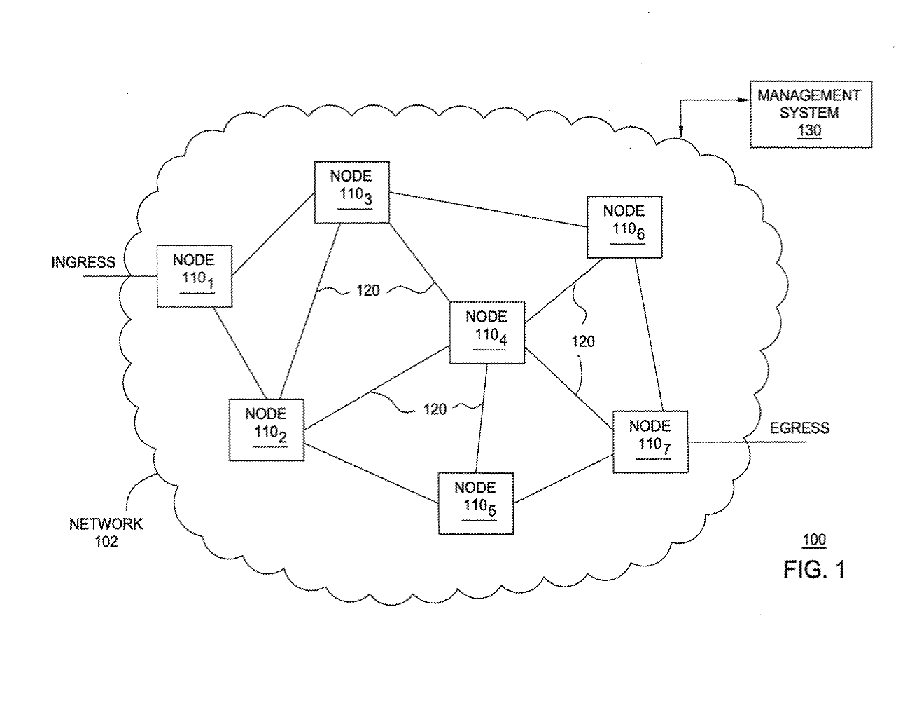

FIG. 1 depicts a high-level block diagram of a communication network benefiting from various embodiments. Specifically, the network 100 of FIG. 1 provides a Generalized Multi-Protocol Label Switching (GMPLS) network supporting Resource Reservation Protocol (RSVP). The network may be modified by those skilled in the art to use other MPLS related protocols rather that the exemplary protocol discussed herein.

As depicted in FIG. 1, exemplary network 100 includes a plurality of nodes 110₁-110₇ (collectively, nodes 110) that are interconnected via a plurality of communication links 120 (collectively, communication links 120). The network 100 is managed by a management system 130, which may provide any suitable management functions for the network 100. While the network 100 may comprise any suitable type of network and, thus, the nodes 110 may be any suitable types of nodes. For example, the network 102 may be an GMPLS network in which nodes 110 are label switching routers (LSRs).

The nodes 110 are configured for transporting traffic within the network 102. The nodes 110 may transport traffic within network 102 using any suitable protocols (e.g., Internet Protocol (IP), MPLS, GMPLS and the like, as well as various combinations thereof). In various embodiments, IP ingress and egress nodes supporting generalized LSPs within the context of a GMPLS system provide thereby IP-Optical integration, and use in one embodiment a modified RFC-4872-type signaling mechanism to achieve rapid end-to-end recovery of an IP-optical-IP path across an Optical domain.

The nodes 110 are configured to collect link state information associated with the communication link(s) 120 to which each node 110 is connected. The nodes 110 are further configured to flood the collected link state information within network 102.

In one embodiment, the collection and flooding of link state information is performed using an Interior Gateway Protocol (IGP) supporting link-state, such as Open Shortest Path First (OSPF), Intermediate System to Intermediate System (IS-IS), or any other suitable protocol. In this manner, each node 110 receives link state information associated with network 102 and, thus, each node 110 is able to maintain a database including information suitable for use in computing paths (e.g., network topology information, link state information, and the like). This type of database is typically referred to as a Traffic Engineering (TE) database.

In network 102, at least a portion of the nodes 110 may be configured to operate as ingress nodes into network 102 and, similarly, at least a portion of the nodes 110 may be configured to operate as egress nodes from network 102. In FIG. 1, for example, for a given path between node 110₁ and node 110₇, node 110₁ operates as an ingress node for the path and node 110₇ operates as an egress node for the path. It will be appreciated that each of the nodes 110 may operate as an ingress node only, an egress node only, or both an ingress and egress node (e.g., for different traffic flows). The ingress and egress nodes for a particular path may provide IP-optical integration by receiving IP traffic at the ingress node, and propagating that traffic via that path through one or more intermediate optical nodes to the egress node.

As each of the nodes 110 may be configured to operate as an ingress node and/or as an egress node, each node 110 configured to operate as an ingress node may be referred to as an ingress node 110 and each node 110 configured to operate as an egress node may be referred to as an egress node 110.

In one embodiment, the ingress nodes 110 each are configured for computing paths to egress nodes 110, thereby enabling establishment of connections, from the ingress nodes 110 to the egress nodes 110, configured for transporting traffic via the network 102. The computed paths may include one or more primary or working paths, as well as one or more associated protection paths. Various embodiments contemplate that a protection path may be associated with more than one working path (i.e., N+1 protection).

The ingress nodes 110, in response to path computation requests, compute the requested paths based on the network information (e.g., network topology, link state, and the like, which may be available in a TE database and/or any other suitable database or databases) and link constraints available to the ingress nodes 110, respectively. The ingress nodes 110, upon computation of paths, may then initiate establishment of connections using the computed paths. The ingress nodes 110 may then transmit information to the egress nodes 110 via the established connections, at which point the egress nodes 110 may then forward the information to other networks and devices.

In one embodiment, MS 130 is configured for computing paths from ingress nodes 110 to egress nodes 110, thereby enabling establishing of connections, from the ingress nodes 110 to the egress nodes 110, configured for transporting traffic via the network 102. The computed paths may include one or more primary or working paths, as well as one or more associated protection paths. Various embodiments contemplate that a protection path may be associated with more than one working path (i.e., N+1 protection).

The MS 130, in response to path computation requests, computes the requested paths based on the network information (e.g., network topology, link state, and the like, which may be available in a TE database and/or any other suitable database or databases) and link constraints available to MS 130. The MS 130, upon computing a path, transmits path configuration information for the computed path to the relevant nodes 110, where the path configuration information may be used to establish a connection via the computed path within network 102. The ingress node 110 of the computed path may then transmit information to the egress node 110 via the connection, at which point the egress node 110 may then forward the information to other networks and devices.

In various embodiments, the network 102 comprises an MPLS network in which nodes 110 are label switching routers (LSRs) operating according to a Generalized Multi-Protocol Label Switching (GMPLS) Label Distribution Protocol (LDP). In various embodiments, ingress and egress nodes or LSRs comprise IP LSRs, wherein optical domain devices therebetween comprise optical LSRs or nodes such as Wavelength Division Multiplexed (WDM) or Optical Crossconnect (OXC) nodes.

Various embodiments provide a mechanism to enable the functionality described herein, wherein the functionality is compatible with IETF RFC 4872 and related standards/proposals.

Various embodiments contemplate a compatible functionality wherein reserved or other information fields contemplated by the standards/proposals are used to allow ACK/NACK communications by each end of a failed or failing working path to provide a controlled and rapid switch to a protection path. Various embodiments provide a new error code value in the error spec object below to communicate that the switchover request has failed.

Various embodiments described herein address a number of problems. For example, various embodiments avoid a lack of visibility between ingress and egress PE nodes or LSRs which may result in inconsistent behavior in an end-to-end protection scheme due to timing or implementation problems at either end during path switchover events. Similarly, various embodiments provide a signaling mechanism wherein a failed switchover request may be quickly identified so that a new switchover may be initiated. Advantageously, efficient resource allocation is provided by quickly releasing those resources associated with failed switchover requests and the like.

### Protection Object

Various embodiments contemplate the use of a protection object to be propagated upstream or downstream between end PE node or LSRs. In one embodiment, the protection object is adapted to include another protection object bit or flag defined along with known [SPNO] flags, such as illustrated below. This additional bit or flag may be used in the protection object to indicate whether a given working Path is successfully bound to a protection LSP or GLSP with resources allocated thereto such as within the context of a 1:N and-to-and protection scheme. This additional bit or flag may be implemented in a manner similar to those flags or bits being conveyed for segment protection through the ‘I’ bit of the protection object, as noted below. Various embodiments contemplate use of the mechanisms described herein for only those working paths associated with protect resources allocated in both ingress and egress nodes to thereby prevent the situation of resources being allocated in one end but not in the other end of an LSP.

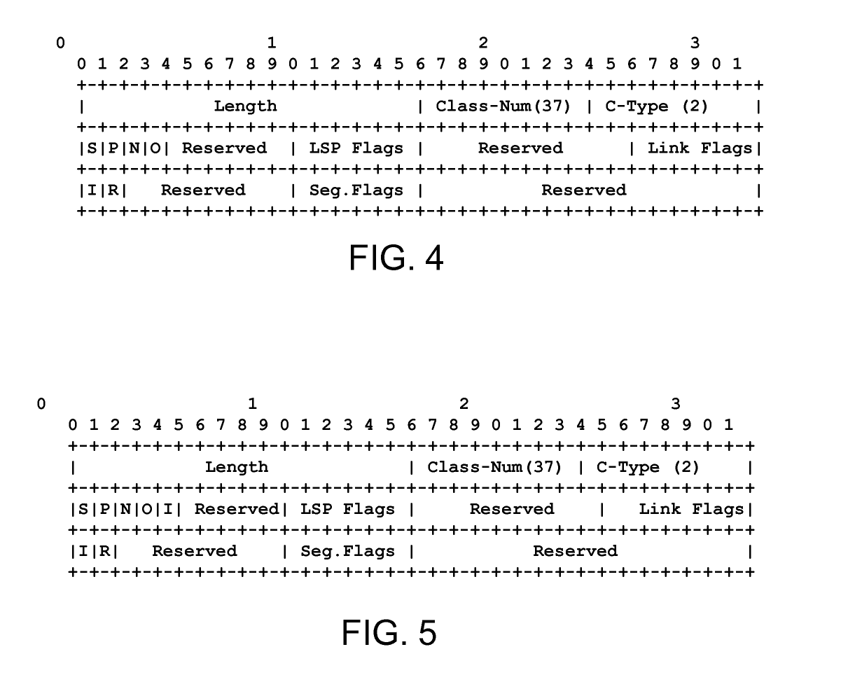

An exemplary protection object may be provided as follows and as shown in FIG. 4:

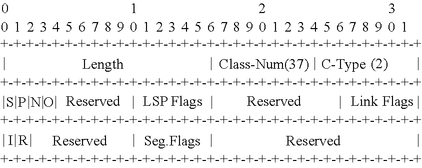

In the above protection object, an In-Place(I) field comprising a 1 bit field which, when set to a first level (e.g., 1) indicates that the desired segment recovery type indicated in the LSP Segment Recovery Flag (or field) is already in place (i.e., bound to the originating node or otherwise provisioned) for the associated LSP. Generally speaking, the protection object fields may comprise 1-bit or multiple bit fields, and the values used to indicate the relevant parameters may be adapted (e.g., logic 1 or logic 0) as desired.

Various embodiments modify the above protection object to define an additional flag or field immediately following the SPNO fields; namely, In-Place(I) field comprising a 1 bit field which, when set to a first level (e.g., 1) indicates that the working path is successfully bound to the protection path. The modified protection object may be provided as follows and as shown in FIG. 5:

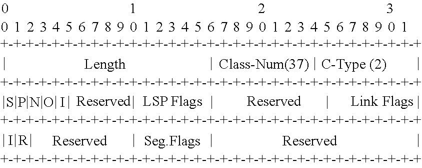

### Notify Message

Various embodiments contemplate the use of a notify message as part of a mechanism enabling communication between LSP end nodes or LSRs (i.e. ingress and egress nodes) as well as intervening and neighboring nodes. This mechanism may be used to trigger a path switchover operation, indicate whether the path switchover operation has succeeded or failed, activate a protection path and/or perform other functions. Generally speaking, the notification message provides a mechanism to inform non-adjacent nodes of LSP related events. In various embodiments, notify messages are normally generated only after a Notify Request object has been received.

For example, in the case of an end node of an LSP unable to comply with a received switchover request message, the end node propagates a notify message toward the switchover request message originating node in which a new error code value within the error spec object portion of a notify message is used to report this failure.

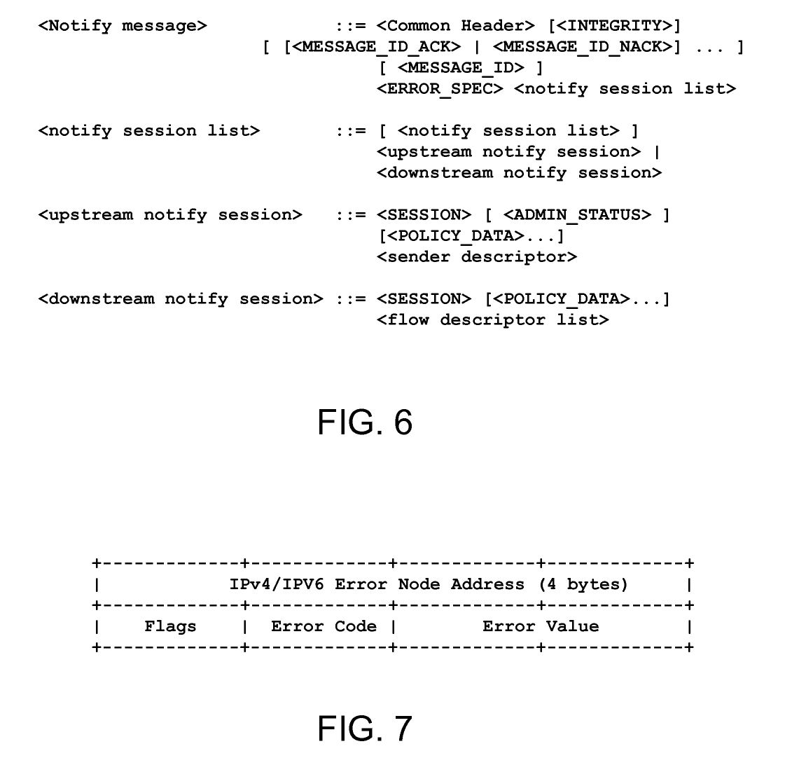

An exemplary notify message has a Message Type of 21, and may use a format such as provided below as shown in FIG. 6:

| | |
|---|---|
| <Notify message> | ::= <Common Header> [<INTEGRITY>] |

[ [<MESSAGE_ID_ACK> | <MESSAGE_ID_NACK>] ... ]

[ <MESSAGE_ID> ]
<ERROR_SPEC> <notify session list>

| | |
|---|---|
| <notify session list> | ::= [ <notify session list> ] |

<upstream notify session> |
<downstream notify session>

| | |
|---|---|
| <upstream notify session> | ::= <SESSION> [ <ADMIN_STATUS> ] |

[<POLICY_DATA>...]
<sender descriptor>

| | |
|---|---|
| <downstream notify session> | ::= <SESSION> [<POLICY_DATA>...] |

<flow descriptor list>

An ERROR_SPEC object may be used to specify the error and may include the IP address of the node that detected the error, the link that has failed or some other information useful in identifying the error. In various embodiments, the ERROR_SPEC may be implemented as described in IETF RFC 2205. Similarly, in various embodiments the MESSAGE_ID and related objects may be implemented in the manner described in IETF RFC 2961, such as when RFC 2961 type functions are supported.

Various embodiments provide a new error code value (e.g., 25 or some other numeric or alphanumeric error code value) in the error spec object below to communicate that the switchover request has failed. In particular, various embodiments contemplate a new error code to indicate end-to-end switchover request failure to the originating node of the switchover request message. For example, the code may be 25 or some other code as desired, and the error value may be a value indicative of the switchover failure parameters (actual bindings, desired bindings, resource information and/or other information). The error code may be provided as follows and as shown in FIG. 7:

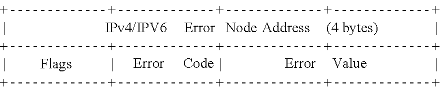

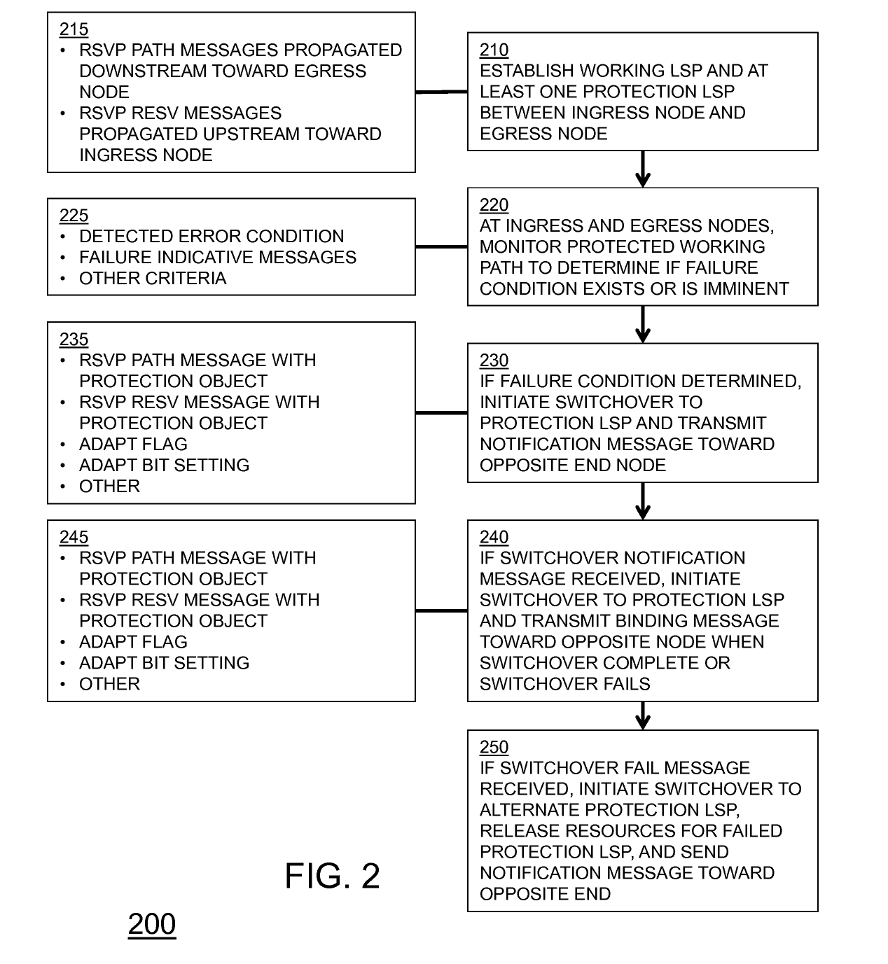

FIG. 2 depicts a flow diagram of a method according to one embodiment. Specifically, FIG. 2 depicts a flow diagram of a method for signaling path bindings between ingress and egress nodes in a manner facilitating rapid switching from working path to protection path (failover) as well as switching from protection path to working path (restoration).

The method 200 of FIG. 2 contemplates that some or all of a plurality of label switching routers (LSRs) associated with various generalized label switched paths (LSPs) through a GM PLS network operate to monitor various operating parameters to determine thereby whether a GM PLS-TE path failure condition exists or is imminent. The path failure condition may be communicated to an ingress node or egress node in a standard manner.

The method 200 of FIG. 2 contemplates an originating end node transmitting a switchover request message to the other end node in response to determining that a switchover is appropriate, and the other and node transmitting a notify message indicative of success or failure of the requested switchover. Various modifications are also contemplated by the inventor.

At step 210, a GLSP is established between an ingress node and an egress node. Referring to box 215, the established GLSP further supports upstream and downstream messages between the various LSRs. Generally speaking, RSVP path messages are propagated downstream from a message originating node toward the egress node, while RSVP Resv messages are propagated upstream from a message originating node toward the ingress node.

At step 220, at each of the ingress and egress nodes, various path monitoring and failure detection mechanisms are employed. In particular, protected working paths are monitored to determine if a failure condition exists or is imminent. In various embodiments, such monitoring is performed elsewhere and the ingress and/or egress nodes receive only an indication of an imminent or actual failure condition associated with a path. Referring to box 225, failure conditions may be determined with respect to a detected error condition (e.g., high error rate, loss of keep alive message and the like), received failure indicative messages and other criteria. For example, an intermediate or transit node or LSR associated with a working path or protection path may be experiencing an actual or imminent overload condition with respect to memory, CPU, input/output and/or other resources, a number of received RSVP packets, a rate of RSVP packet reception, a number of dropped RSVP packet, the rate at which RSVP packets are dropped, one or more resource utilization threshold levels and/or other mechanisms. A GMPLS/RSVP task processing mechanism at the node or LSR may continue polling system resource utilization and/or RSVP packet reception statistics to identify such imminent or actual failure conditions.

At step 230, in response to receiving information or otherwise determining at a provider edge (PE) ingress or egress node or LSR that a working path failure condition exists or is imminent, a switchover from the working path to a protection path is initiated, and a switchover notification message is transmitted toward the opposite end PE node or GLSP. For example, if initiated at an egress node, the switchover notification message originates at the egress node and is transmitted toward a corresponding ingress node. Similarly, if initiated at an ingress node, the switchover notification message originates at the ingress node and is transmitted toward a corresponding egress node.

Referring to box 235, a switchover notification message transmitted from an egress node toward an ingress node comprises an upstream RSVP Resv message including a protection object configured to indicate to the receiving ingress node the protection path resource bindings of the egress node. Similarly, a notification message transmitted from an ingress node toward an egress node comprises a downstream RSVP Path message including a protection object configured to indicate to the receiving egress node the protection path resource bindings of the ingress node. The various bindings and other information conveyed via a protection object may be indicated by adapting flags, bit settings and other information associated with a protection object such as described herein.

At step 240, in response to receiving a switchover notification message, the receiving node initiates a corresponding switchover from the working path to the protection path in accordance with the protection path resource bindings indicated within the received switchover notification message. In addition, a positive acknowledgment message (ACK) or negative acknowledgment message (NACK) is transmitted toward the originating PE node or GLSP associated with the received switchover notification message in response to, respectively, the receiving node or GLSP successfully or unsuccessfully switching over from the working path to the protection path.

Referring to box 245, an ACK or NACK notification message transmitted from an egress node toward an ingress node comprises an upstream RSVP Resv message including a protection object configured to indicate to the receiving ingress node the protection path resource bindings of the egress node. Similarly, an ACK or NACK message transmitted from an ingress node toward an egress node comprises a downstream RSVP Path message including a protection object configured to indicate to the receiving egress node the protection path resource bindings of the ingress node. The various bindings and other information conveyed via a protection object may be indicated by adapting flags, bit settings and other information associated with a protection object such as described herein. In particular, notification messages may be propagated from an originating PE node as an indication of recovery of working path network elements such that restoration of the working path may be provided. Upon restoring the working path, the protection path resources may be released or allocated back towards protecting other working paths.

At step 250, if a switchover notification message originating PE node or GLSP receives a corresponding switchover fail message (NACK message), then the originating PE node or GLSP may initiate a switchover to an alternate protection GLSP and transmits a switchover notification message toward the opposite end node such as described above with respect to step 230. Optionally, those resources associated with the failed protection path switchover are released for by other paths, nodes or LSRs as appropriate.

It will be appreciated that the steps described above with respect to a failover operation (i.e., traffic from a working path moved to a protection path) are readily adapted to implement a restoration operation (i.e., traffic from a protection path moving to a restored working path).

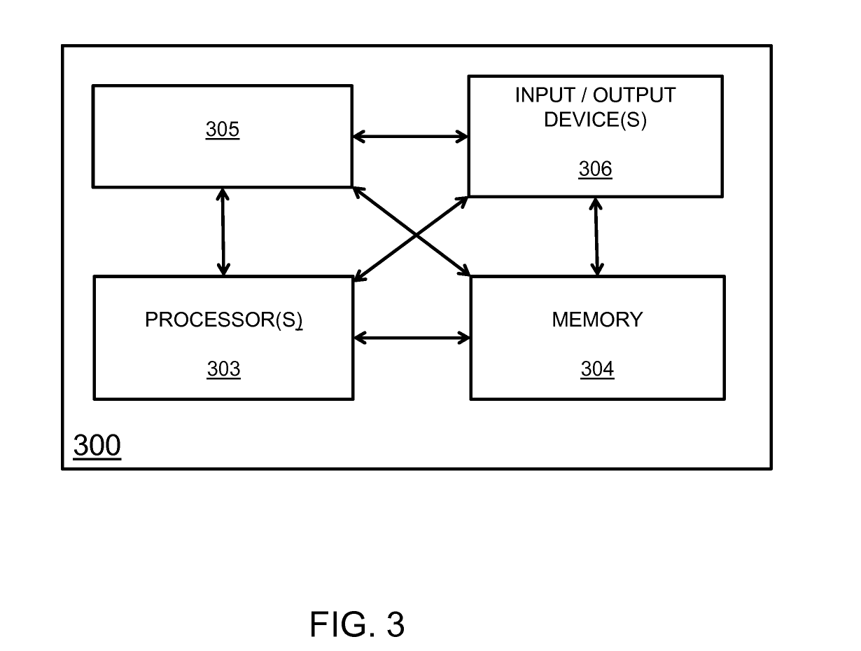

FIG. 3 depicts a high-level block diagram of a computing device, such as a processor in a telecom network element, suitable for use in performing functions described herein, such as the various network management functions, LSR functions, path failure determination or indication functions, switchover request functions, success/failure notify functions and so on associated with the various elements described above with respect to the figures.

FIG. 3 depicts a high-level block diagram of a computing device, such as a processor in a telecom network element, suitable for use in performing functions described herein such as those associated with the various elements described herein with respect to the figures.

As depicted in FIG. 3, computing device 300 includes a processor element 303 (e.g., a central processing unit (CPU) and/or other suitable processor(s)), a memory 304 (e.g., random access memory (RAM), read only memory (ROM), and the like), a cooperating module/process 305, and various input/output devices 306 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in hardware and/or in a combination of software and hardware, e.g., using a general purpose computer, one or more application specific integrated circuits (ASIC), and/or any other hardware equivalents. In one embodiment, the cooperating process 305 can be loaded into memory 304 and executed by processor 303 to implement the functions as discussed herein. Thus, cooperating process 305 (including associated data structures) can be stored on a computer readable storage medium, e.g., RAM memory, magnetic or optical drive or diskette, and the like.

It will be appreciated that computing device 300 depicted in FIG. 3 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods and/or techniques described herein are invoked or otherwise provided. Instructions for invoking the inventive methods may be stored in tangible and non-transitory computer readable medium such as fixed or removable media or memory, and/or stored within a memory within a computing device operating according to the instructions.

Various modifications may be made to the systems, methods, apparatus, mechanisms, techniques and portions thereof described herein with respect to the various figures, such modifications being contemplated as being within the scope of the invention. For example, while a specific order of steps or arrangement of functional elements is presented in the various embodiments described herein, various other orders/arrangements of steps or functional elements may be utilized within the context of the various embodiments. Further, while modifications to embodiments may be discussed individually, various embodiments may use multiple modifications contemporaneously or in sequence, compound modifications and the like. For example, various embodiments contemplate an apparatus, comprising a processor configured for performing methods and processes such as described herein.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method of signaling path bindings supporting a generalized label switched path (LSP) comprising at least one working path and at least one protection path between end nodes, comprising:
at an LSP end node, in response to a successful resource binding for said protection path, transmitting a first protection path binding message indicative of said successful resource binding toward an opposite LSP end node via one of a PATH message and an RSVP message.

2. The method of claim 1, wherein said first protection path binding message comprises a protection object including therein a binding status indicator for indicating said successful resource binding.

3. The method of claim 1, further comprising:
at said LSP end node, in response to a working path failure condition, binding said working path to a protection path and transmitting a second protection path binding message indicative of binding said working path to said protection path toward an opposite LSP end node via one of a PATH message and an RSVP message.

4. The method of claim 3, wherein said second protection path binding message comprises a protection object including therein a binding status indicator for indicating said successful resource binding.

5. The method of claim 1, wherein said LSP traverses an optical domain, said PATH message being transmitted by an LSP ingress node toward a corresponding LSP egress node, said RSVP message being transmitted by an LSP egress mode toward a corresponding LSP ingress node.

6. The method of claim 2, wherein data in a first field of said protection path object is indicative of said successful resource binding.

7. The method of claim 6, wherein data in a second field of said protection path object indicates a segment recovery type.

8. The method of claim 7, wherein the first field comprises an In-Place(I) field and the second field comprises a LSP Segment Recovery field.

9. The method of claim 3, further comprising:
at said LSP end node, in response to a working path recovery condition, binding said protection path to said working path and transmitting a third protection path binding message indicative of binding said protection path to said working path toward an opposite LSP end node via one of a PATH message and an RSVP message.

10. The method of claim 9, further comprising:
at said LSP end node, releasing resources associated with said protection path binding.

11. An apparatus configured for signaling path bindings supporting a generalized label switched path (LSP) comprising at least one working path and at least one protection path between end nodes, the apparatus comprising a processor configured to perform a method comprising:
at an LSP end node, in response to a successful resource binding for said protection path, transmitting a first protection path binding message indicative of said successful resource binding toward an opposite LSP end node via one of a PATH message and an RSVP message.

12. The apparatus of claim 11, wherein said first protection path binding message comprises a protection object including therein a binding status indicator for indicating said successful resource binding.

13. A computer program product wherein computer instructions, when executed by a processor in a telecom network element, adapt the operation of the telecom network element to provide a method for signaling path bindings supporting a generalized label switched path (LSP) comprising at least one working path and at least one protection path between end nodes, the apparatus comprising a processor configured to perform a method comprising:
at an LSP end node, in response to a successful resource binding for said protection path, transmitting a first protection path binding message indicative of said successful resource binding toward an opposite LSP end node via one of a PATH message and an RSVP message.

14. A tangible and non-transient computer readable storage medium storing instructions which, when executed by a computer, adapt the operation of the computer to provide a method for signaling path bindings supporting a generalized label switched path (LSP) comprising at least one working path and at least one protection path between end nodes, the method comprising:
at an LSP end node, in response to a successful resource binding for said protection path, transmitting a first protection path binding message indicative of said successful resource binding toward an opposite LSP end node via one of a PATH message and an RSVP message.
